(19) United States
(12) Patent Application Publication
(10) Pub. No.: US 2006/0093714 A1
(43) Pub. Date: May 4, 2006

(54) Particulate ice cream dot cake

(75) Inventor: Anne Nelson, Paducah, KY (US)

Correspondence Address: STOCKWELL & ASSOCIATES, PSC, 861 CORPORATE DRIVE, SUITE 201, LEXINGTON, KY, 40503, US

(73) Assignee: Dippin' Dots, Inc.

(21) Appl. No.: 11/259,564

(22) Filed: Oct. 26, 2005

Related U.S. Application Data
(60) Provisional application No. 60/623,913, filed on Nov. 1, 2004.

(51) Int. Cl. A23G 3/02; A23L 3/36; A23C 3/00

(52) U.S. Cl. 426/512; 426/524

(57) ABSTRACT

This invention relates generally to a cake made from particulate ice cream, and to a customized box for holding these cakes.

### CROSS-REFERENCE TO RELATED APPLICATIONS

This application claims priority to U.S. Provisional Application No. 60/623,913, which was filed on Nov. 1, 2004.

### FIELD OF THE INVENTION

The present invention relates to novel combinations of cryogenic ice cream products.

### BACKGROUND OF THE INVENTION

Cryogenically frozen ice cream can be sold in a variety of forms.

### SUMMARY OF THE INVENTION

It is an object of the present invention to comprise a cake of which the main ingredient is cryogenically frozen particulate ice cream. It is another object of the present invention to provide a method of manufacturing the cake that can be easily and consistently applied. These and other objects and advantages of the invention will become readily apparent as the following description is read in conjunction with the accompanying drawings.

### BRIEF DESCRIPTION OF THE DRAWINGS

FIG. 1 is a plan view of the mechanism for manufacturing the particulate ice cream used in the present invention;

FIG. 2 is a flowchart describing how to manufacture the present invention;

FIGS. 3A and 3B are packaged and unpackaged views of the present invention;

FIGS. 4A and 4B show an exemplary serving method for the present invention; and

FIGS. 5A-5D show a suggested box for packaging and transporting the present invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

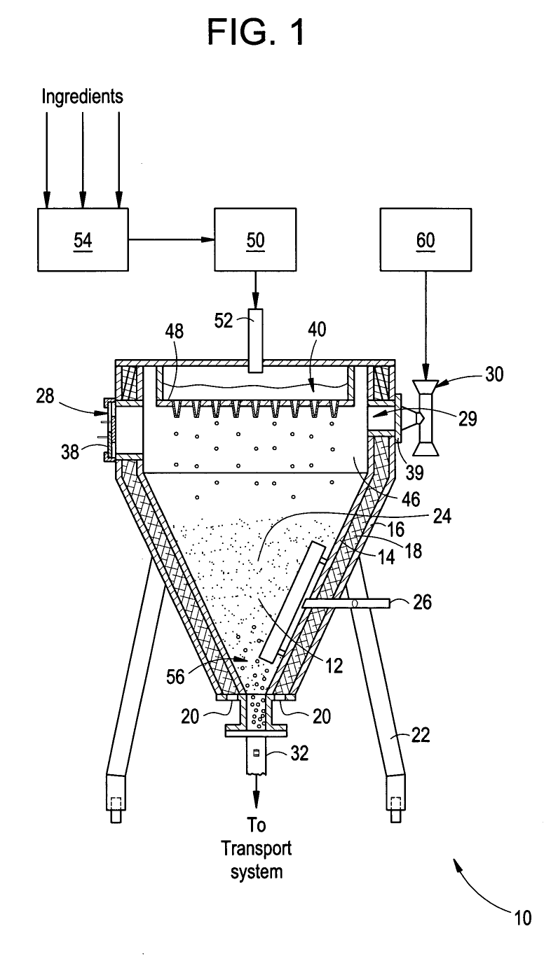

FIG. 1 shows a cryogenic processor constructed in accordance with the preferred embodiment of the present invention to produce free-flowing particulate ice cream 56. The fundamental method utilized to produce the product is described in detail in U.S. Pat. No. 5,126,156, which is hereby incorporated by reference.

A cryogenic processor 10 includes a freezing chamber 12 that is most preferably in the form of a conical tank that holds a liquid refrigerant therein. A freezing chamber 12 incorporates an inner shell 14 and an outer shell 16. Insulation 18 is disposed between the inner shell 14 and outer shell 16 in order to increase the thermal efficiency of the chamber 12. Vents 20 are also provided to ventilate the insulated area formed between the shells 14 and 16. The freezing chamber 12 is a free-standing unit supported by legs 22.

A refrigerant 24, preferably liquid nitrogen, enters the freezing chamber 12 by means of refrigerant inlet 26. The refrigerant 24 is introduced into a chamber 12 through the inlet 26 in order to maintain a predetermined level of liquid refrigerant in the freezing chamber because some refrigerant 24 can be lost by evaporation or by other means incidental to production. Gaseous refrigerant that has evaporated from the surface of the liquid refrigerant 24 in freezing chamber 12 primarily vents to the atmosphere through exit port 29 which cooperates with the vacuum assembly 30, which can be in the form of a venturi nozzle. Extraction of the frozen beads occurs through product outlet 32 adapted at the base of the freezing chamber 12.

An ambient air inlet port 28 with adjustment doors 38 and exit port 29 with adjustment doors 39 are provided to adjust the level of gaseous refrigerant which evaporates from the surface of the liquid refrigerant 24 so that excessive pressure is not built up within the processor 10 and freezing of the liquid composition in the feed assembly 40 does not occur.

A feed tray 48 receives liquid composition from a delivery source 50. Typically, a pump (not shown) drives the liquid composition through a delivery tube 52 into the feed tray 48. A premixing device 54 allows several compositions, not all of which must be liquid, such as powdered flavorings or other additives of a size small enough not to cause clogging in the feed assembly 40, to be mixed in predetermined concentrations for delivery to the feed tray 48.

In order to create uniformly sized particles or particulate ice cream 56 of frozen product, uniformly sized droplets of liquid composition are required to be fed through gas diffusion chamber 46 to freezing chamber 12. The feed tray 48 is designed with feed assembly 40 that forms droplets of the desired character. The frozen product takes the form of beads that are formed when the droplets 58 of liquid composition contact the refrigerant vapor in the gas diffusion chamber 46, and subsequently the liquid refrigerant 24 in the freezing chamber 12. After the particulate ice cream 56 are formed, they fall to the bottom of chamber 12. A transport system connects to the bottom of chamber 12 at outlet 32 to carry the particulate ice cream 56 to a packaging and distribution network for later delivery and consumption.

The vacuum assembly 30 cooperates with air inlet 28 and adjustment doors 38 so that ambient air flows through the inlet and around feed assembly 40 to ensure that no liquid composition freezes therein. This is accomplished by mounting the vacuum assembly 30 and air inlet 28 on opposing sides of the gas diffusion chamber 46 such that the incoming ambient air drawn by the vacuum assembly 30 is aligned with the feed assembly. In this configuration, ambient air flows around the feed assembly warming it to a sufficient temperature to inhibit the formation of frozen liquid composition in the feed assembly flow channels. An air source 60, typically in the form of an air compressor, is attached to vacuum assembly 30 to provide appropriate suction to create the ambient air flow required.

A kit for assembling the cake 100 of the present invention contains four pouches: a crust mix, a crust binding agent to keep the crust mix together, a syrup binding agent to keep the particulate ice cream 56 together, and optional (within various embodiments) cake pieces. All pouches contain predetermined amounts of ingredients, and these amounts are carefully calibrated to achieve uniformity and consistency. To assemble the present invention requires two plastic bowls, a spatula, a storage freezer capable of temperatures of −40° F., and a sanitary work area.

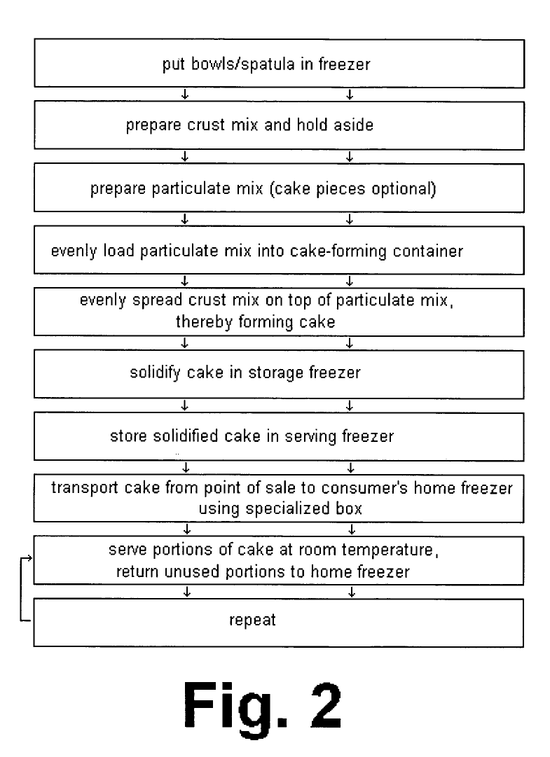

The assembler should first place the two plastic bowls and spatula within a −40° F. freezer for at least 5 minutes, because the beads 56 tend to quickly melt at typical room temperatures. Accordingly, it is important that the assembler move quickly during all the steps of the present invention, which are summarized in FIG. 2.

The assembler will remove a bowl and spatula from the freezer, shake the pouch of crust mix into the frozen bowl, and then combine the crust binding agent into the crust mix, and then blend with spatula until fully combined. This forms the crust of the cake 100 of the present invention, which should be held in abeyance pending completion of the next step.

The assembler should then remove second chilled bowl from freezer and scoop five scoops of particulate ice cream 56 into the second bowl. The assembler should then empty the syrup binding agent into the bowl of particulate ice cream 56 and mix with the spatula. Optionally, the assembler can also empty the pouch of cake pieces into the combination of syrup binding agent and particulate ice cream 56. In either case, working quickly yet without mashing, the assembler will lift and evenly fold the particulate mixture from the bottom, ensuring that the particulate ice cream 56 gets covered and that all ingredients are evenly dispersed.

The assembler will then empty the mixture into a plastic round container 104 specifically designed to form the above particulate mixture into the desired cake shape. Using the spatula, the assembler will gently press the mixture so that the surface is flat and even, but will avoid pressing so hard that the particulate 56 melts on the face of the cake-forming container 104. The user puts the particulate ice cream 56 on the bottom of the cake-forming container 104, which should rise to a quarter-inch (at most) from the top of the container 104.

Upon completion of the above, the assembler will empty the crust combination held in abeyance from the first plastic bowl onto the particulate mixture, and gently press the crust mixture onto the surface of the particulate mixture until all particulate 56 is covered and the crust bottom is smooth and level and having an even surface. The container 104 has a cardboard bottom that has a glossy side and a dull side. The cake contacts the glossy side to prevent sticking. The assembler puts the cardboard bottom on the cake and snaps a lid onto the cake.

It is necessary to then place the combination in a −40° F. storage freezer overnight. The combination can then be stored in a serving freezer pre-configured to have a temperature of no higher than −20° F. After this freezing process, the cake 100 is stored in a conventional freezer (−10° to +5° F.).

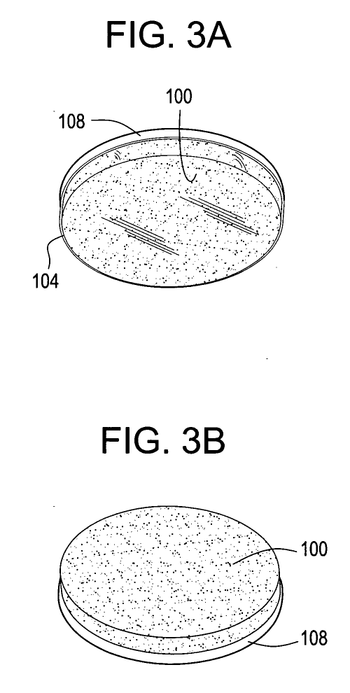

Once the cake 100 is completely frozen, the cake-forming container 104 is no longer involved in formation. The assembler then turns the cake 100 upside down and entirely removes the container 104, as shown in FIG. 3B.

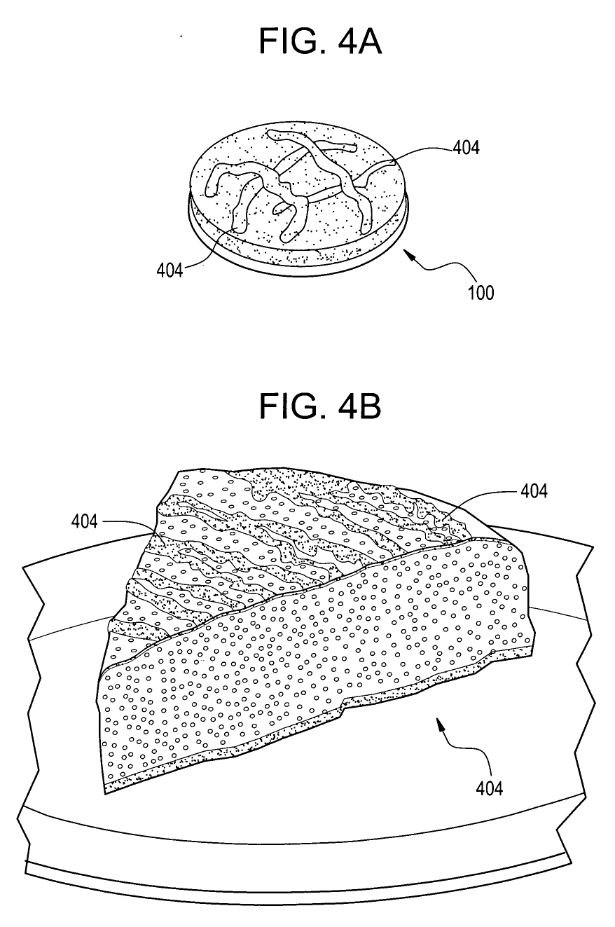

When a customer arrives, the assembler can create multi colored chocolate linear patterns such as those shown in FIG. 4A, including potentially blue patterns, although red, yellow, and chocolate are contemplated within the spirit and scope of the present invention. Blue is advantageous because blue is a rare color for food products and considered to be attractive by potential purchasers.

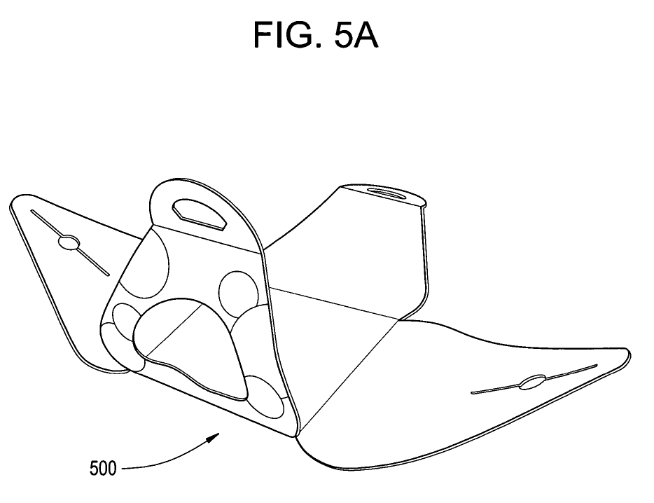

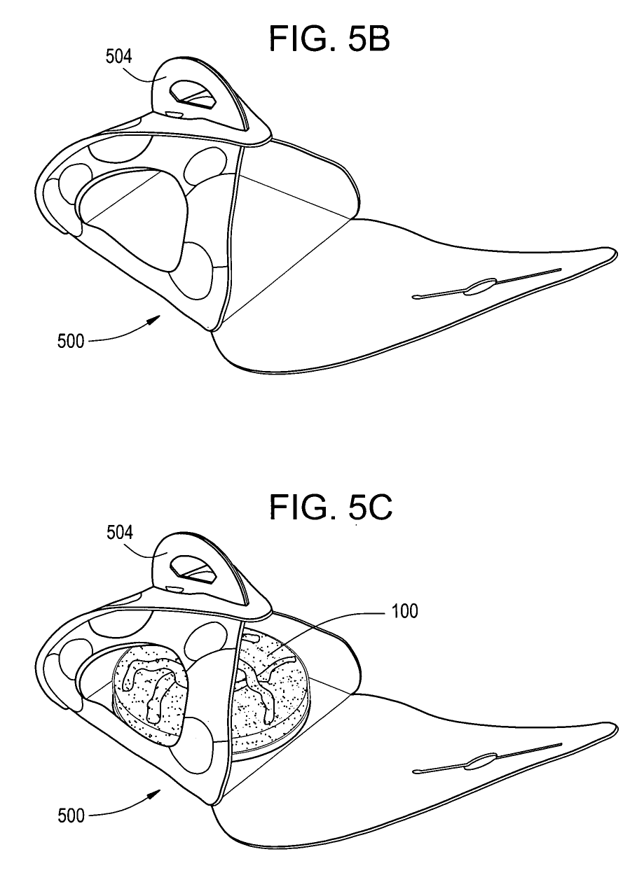

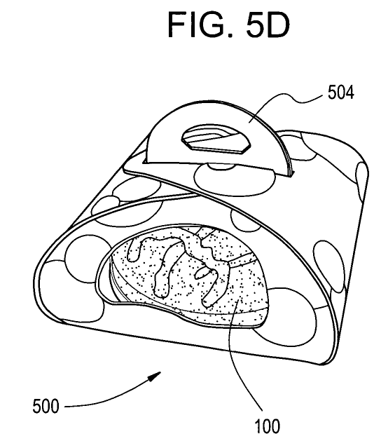

At the point of sale, a sales clerk puts the cake inside the specially-formed box 500 as shown in FIG. 5A. The box 500 has a square bottom and four flaps which meet to form a handle 504, as shown in FIGS. 5B, 5C, and 5D.

As shown in FIG. 5B, when the user folds up the box 500, it has a rounded look on its overlapping edges. The handle 504 actually snaps in place over the box 500, so the user can hold the box 500, while the handle remains in place. One side of the box 500 has a cut out with a translucent plastic shield located therein. The box 500 has a square bottom, although the sides bulge out in a rounded fashion.

One aesthetically attractive feature of the box 500 is its round look and patterns, including large bright dots and tapering. As shown in FIGS. 5C-5D, the corners are rounded, with the large round dots on the sides. The roundedness makes the box 500 look marketable and enhances image appeal.

In an exemplary embodiment, the cake 100 is cylindrical, about 3 inches tall, and about a foot in diameter. However, these dimensions are for exemplary purposes only, so that the present invention should not be considered as limited exclusively thereto.

After being stored in a special −40° F. freezer, as stated a customer can then store the present invention in a conventional freezer. This is partly because the syrup binding agent has a high melting point and thus ensures the particulate ice cream 56 maintains its spherical, unmelted shapes at a higher temperature.

FIG. 4B shows an exemplary serving suggestion for a slice of the cake 100 after it has been removed from the box 500. FIG. 4B also shows detail about the interior of the cake 100, as well as decorative stripes and patterns 404 which can come in a variety of colors.

It is anticipated that various changes may be made in the arrangement and operation of the system of the present invention without departing from the spirit and scope of the invention, as shown in the following claims.

What is claimed is:

1. A particulate ice cream cake, comprising:
crust mix,
a crust binding agent to keep the crust mix together,
a syrup binding agent to keep the particulate ice cream together, and
particulate ice cream.

2. The cake of claim 1, further comprising:
cake pieces.

3. The cake of claim 1, further comprising:
a container for forming and then storing the cake.

4. The cake of claim 1, further comprising:
wherein a box for holding said cake has a square bottom, overlapping edges, and a matching insertion flap.

5. The cake of claim 4, further comprising:
said box has a rounded look on said overlapping edges.

6. The cake of claim 4, further comprising:
a handle is formed in the box pattern.

7. The cake of claim 6, further comprising:
said handle snaps in place over the box.

8. The cake of claim 1, further comprising:
one side of said box has cut-out with a plastic shield located therein, for viewing said cake.

9. The cake of claim 1, further comprising:
wherein said cake is cylindrical, about 3 inches tall, and about a foot in diameter.

10. A method of preparing a particulate ice cream cake, comprising:
cryogenically freezing ice cream into particulate components;
combining a crust mix with a crust binding agent in pre-configured proportions;
combining said particulate within a binding agent in pre-configured proportions;
mixing said binded particulate in a pre-frozen bowl;
locating said binded particulate in a pre-formed container;
evenly spreading said crust combination on top of said binded particulate within said container thereby forming a cake;
attaching a packaging base and lid;
inverting said cake;
storing said cake within a storage freezer pre-configured to have a temperature of no higher than −40° F. overnight;
displaying said cake within a serving freezer pre-configured to have a temperature of no higher than −20° F.; and
storing said cake within a conventional freezer pre-configured to have a temperature of −5° F. to +10° F.

11. The method of claim 10, wherein said locating step further comprises:
locating five scoops of particulate ice cream into a second bowl.

12. The method of claim 10, wherein said locating step further comprises:
emptying the syrup binding agent into the bowl of particulate ice cream and mix with the spatula.

13. The method of claim 10, wherein said locating step further comprises:
locating cake pieces into the combination of syrup binding agent and particulate ice cream.

14. The method of claim 9, further comprising:
lifting and evenly folding the mixture from the bottom;
ensuring that the particulate ice cream gets covered and that all ingredients are evenly dispersed.
